(19) United States
(12) Patent Application Publication
(10) Pub. No.: US 2012/0055346 A1
(43) Pub. Date: Mar. 8, 2012

(54) CARDIO GRILL

(76) Inventor: Ravi Navare, Mableton, GA (US)

(21) Appl. No.: 12/875,085

(22) Filed: Sep. 2, 2010

(51) Int. Cl. A47J 37/10; A47J 36/00

(52) U.S. Cl. 99/445; 99/446

(57) ABSTRACT

A cardio grill is provided. In various embodiments, a grill pan insert, a grill pan, and a grill pan assembly are disclosed. In at least one embodiment, a grill pan insert includes a food support frame having a disc-shaped base and adapted for removable insertion into a traditional cooking pan and defined to rest flatly, without support members, upon a floor surface of the pan and a grill pattern assembly defined by a plurality of ribs disposed in a generally parallel manner upon the disc-shaped base of the food support frame and having steep high narrow peaks to simulate a wire grate grill pattern imprint upon a food item and from which to drain fats, oils, juices, and the like away from the food item, a plurality of deep trenches alternatingly interposed between the plurality of ribs on the food support frame and having a generally U-shaped pattern.

### FIELD OF THE INVENTION

The technology described herein relates generally to devices for use in cooking foods in a health-conscious manner. More specifically, this technology relates to devices, systems, and associated methods for holding and supporting foods to be cooked by cardio grilling with a cardio grill pan insert, cardio grill pan, and cardio grill pan assembly.

### BACKGROUND OF THE INVENTION

There exists an increasing trend to create healthy meals and to prepare foods in a healthier manner. Known grills, having the objective of creating healthier foods, typically separate excess fats, oils, and juices from the food being prepared. The resultant cooked food prepared in this manner generally has a lower fat and cholesterol content, and is, thereby, presumably healthier. Deficiencies and limitations exist with the known grills of this type. Despite the numerous grills, gridirons, and cooking utensils known in the background art, there remains a need for a simple and efficient cardio grill with improved features.

Related utility patents known in the art include the following: U.S. Pat. No. 175,067 issued to Gates on Mar. 21, 1876, discloses a cooking utensil. U.S. Pat. No. 199,822 issued to Geyser on Jan. 29, 1878, discloses a broiler. U.S. Pat. No. 265,608 issued to Johnston on Oct. 10, 1882, discloses a gridiron. U.S. Pat. No. 389,602 issued to Sankey on Sep. 18, 1888, discloses a gridiron. U.S. Pat. No. 472,537 issued to Griswold et al. on Apr. 12, 1892, discloses a gridiron. U.S. Pat. No. 640,030 issued to Rietzke on Dec. 26, 1899, discloses a kitchen stove utensil. U.S. Pat. No. 676,479 issued to Wagner on Jun. 18, 1901, discloses a broiler. U.S. Pat. No. 1,733,450 issued to Detwiler on Oct. 29, 1929, discloses a cooking utensil. U.S. Pat. No. 1,899,682 issued to Goldenberg on Feb. 28, 1933, discloses a gridiron. U.S. Pat. No. 4,121,510 issued to Frederick on Oct. 24, 1978, discloses a combination cooking rack and pan. U.S. Pat. No. 5,211,105 issued to Liu on May 18, 1993, discloses a smokeless and scorchless grill pan. U.S. Pat. No. 5,453,574 issued to Zuran et al. on Sep. 26, 1995, discloses an eco-grill pan. U.S. Pat. No. 5,467,691 issued to Koziol on Nov. 21, 1995, discloses a cooking grid. U.S. Pat. No. 6,405,642 issued to Morris on Jun. 18, 2002, discloses a food grilling device for a skillet. U.S. Pat. No. 7,059,318 issued to Cornfield on Jun. 13, 2006, discloses a multi-purpose stovetop grilling and cooking device. U.S. Pat. No. 7,415,922 issued to Cheng on Aug. 26, 2008, discloses a grill pan. U.S. Pat. No. 7,506,579 issued to Worton et al. on Mar. 24, 2009, discloses a heating rack.

Related design patents known in the art include the following: U.S. Pat. No. D610,405 issued to McConnell on Feb. 23, 2010, discloses the ornamental design for a cooking grid. U.S. Pat. No. D538,584 issued to Scholze et al. on Mar. 20, 2007, discloses the ornamental design for a square reversible grill pan/griddle.

Related patent application publications known in the art include the following: U.S. Patent Application Publication No. 2009.0205513, filed by Sacherman et al. and published on Aug. 20, 2009, discloses an indoor range-top grill.

The foregoing patent information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a cardio grill pan insert, cardio grill pan, and cardio grill pan assembly, and associated methods for a holding, supporting, and cooking foods by cardio grilling.

In one exemplary embodiment, the technology described herein provides a grill pan insert. The grill pan insert includes: a food support frame having a disc-shaped base and adapted for removable insertion into a traditional cooking pan and defined to rest flatly, without support members, upon a floor surface of the pan; and a grill pattern assembly defined by a plurality of ribs disposed in a generally parallel manner upon the disc-shaped base of the food support frame and having steep high narrow peaks to simulate a wire grate grill pattern imprint upon a food item and from which to drain fats, oils, juices, and the like away from the food item, a plurality of deep trenches alternatingly interposed between the plurality of ribs on the food support frame and having a generally U-shaped pattern.

The disc-shaped base of the food support frame is adapted to receive and evenly distribute heat from the underlying traditional cooking pan.

In at least one embodiment, each of the plurality of ribs is a height selected from the range of 0.75 inches to 1.00 inches in height from the disc-shaped base.

In at least one embodiment, the plurality of ribs includes a first portion of ribs at a first height and a second portion of ribs at a second height, such that the grill pan insert has ribs of varied heights.

In at least one embodiment, the plurality of ribs includes a first portion of ribs at a first height selected from the range of 0.75 inches to 1.00 inches in height from the disc-shaped base and a second portion of ribs at a second height that is higher than the first height, such that the grill pan insert has ribs of varied heights.

In at least one embodiment, the plurality of ribs includes a plurality of rib sections, each section having a varied height, such that the grill pan insert has ribs of varied heights.

In at least one embodiment, the grill pan insert is manufactured from anodized aluminum.

In another exemplary embodiment, the technology described herein provides a grill pan. The grill pan includes: a pan within which to cook food; a grill pattern assembly defined by a plurality of ribs disposed in a generally parallel manner integrally formed with and emanating from a floor of the pan and having steep high narrow peaks to simulate a wire grate grill pattern imprint upon a food item and from which to drain fats, oils, juices, and the like, away from the food item, a plurality of deep trenches alternatingly interposed between the plurality of ribs on the floor of the pan and having a generally U-shaped pattern; and a pan handle with which to grasp and lift the grill pan.

In at least one embodiment the grill pan includes a lift handle disposed upon a pan rim opposite the pan handle.

In at least one embodiment the grill pan includes a pour spout through which to drain the fats, oils, juices, and the like away from the food item.

In at least one embodiment the grill pan includes wherein each of the plurality of ribs is a height selected from the range of 0.75 inches to 1.00 inches in height from the floor of the pan.

In at least one embodiment the grill pan includes wherein the plurality of ribs includes a first portion of ribs at a first height and a second portion of ribs at a second height, such that the grill pan insert has ribs of varied heights.

In at least one embodiment the grill pan includes wherein the plurality of ribs includes a first portion of ribs at a first height selected from the range of 0.75 inches to 1.00 inches in height from the floor of the pan and a second portion of ribs at a second height that is higher than the first height, such that the grill pan has ribs of varied heights.

In at least one embodiment the grill pan includes wherein the plurality of ribs includes a plurality of rib sections, each section having a varied height, such that the grill pan insert has ribs of varied heights.

In at least one embodiment the grill pan includes wherein the grill pan is manufactured from anodized aluminum.

In another exemplary embodiment, the technology described herein provides a grill pan assembly. The grill pan assembly includes: a pan within which to cook food; a grill pattern assembly defined by a plurality of ribs disposed in a generally parallel manner integrally formed with and emanating from a floor of the pan and having steep high narrow peaks to simulate a wire grate grill pattern imprint upon a food item and from which to drain fats, oils, juices, and the like, away from the food item, a plurality of deep trenches alternatingly interposed between the plurality of ribs on the floor of the pan and having a generally U-shaped pattern; a tiered wire grate adapted for placement within the pan to create a tiered cooking platform; and a lid adapted to sealably cover the pan.

In at least one embodiment, the grill pan assembly also includes: a pan handle with which to grasp and lift the grill pan; a lift handle disposed upon a pan rim opposite the pan handle; a pour spout through which to drain the fats, oils, juices, and the like away from the food item; a plurality of adjustable vents disposed within the lid; and a thermometer removably disposed within lid.

In at least one embodiment, the grill pan assembly also includes wherein each of the plurality of ribs is a height selected from the range of 0.75 inches to 1.00 inches in height from the floor of the pan.

In at least one embodiment, the grill pan assembly also includes wherein the plurality of ribs includes a plurality of rib sections, each section having a varied height, such that the grill pan insert has ribs of varied heights.

In at least one embodiment, the grill pan assembly also includes wherein the plurality of ribs includes a first portion of ribs at a first height and a second portion of ribs at a second height, such that the grill pan insert has ribs of varied heights.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a grill pan, illustrating, in particular, a plurality of ribs, and interposed trenches, to support a food item above the pan floor surface, according to an embodiment of the technology described herein;

FIG. 2 is a top planar view of the grill pan depicted in FIG. 1;

FIG. 3 is a cross-sectional end view of the grill pan depicted in FIG. 1;

FIG. 4 is a cross-sectional side view of the grill pan depicted in FIG. 1;

FIG. 5 is a front perspective view of a grill pan insert, according to an embodiment of the technology described herein;

FIG. 6 is a top planar view of the grill pan insert depicted in FIG. 5;

FIG. 7 is a side planar view of the grill pan insert depicted in FIG. 5;

FIG. 8 is an expanded front perspective view of a grill pan assembly, according to an embodiment of the technology described herein;

FIG. 9 is an expanded rear perspective view of the grill pan assembly depicted in FIG. 1;

FIG. 10 is a side view of the grill pan assembly depicted in FIG. 1;

FIG. 11 is a top view of the grill pan assembly depicted in FIG. 1; and

FIG. 12 is a cross-sectional end view of the grill pan depicted in FIG. 1, illustrating, in particular, an alternative embodiment, wherein the ribs are varied in height.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a non-electric cardio grill pan insert, cardio grill pan, and cardio grill pan assembly, and associated methods for a holding, supporting, and cooking foods by cardio grilling.

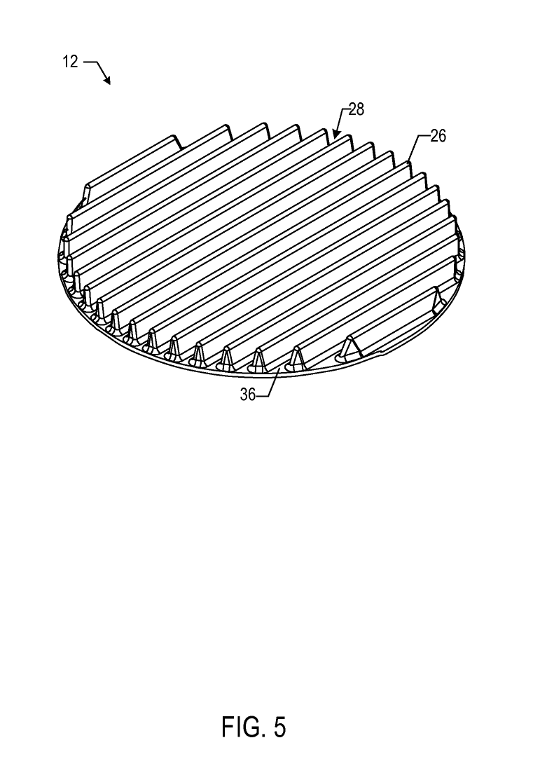

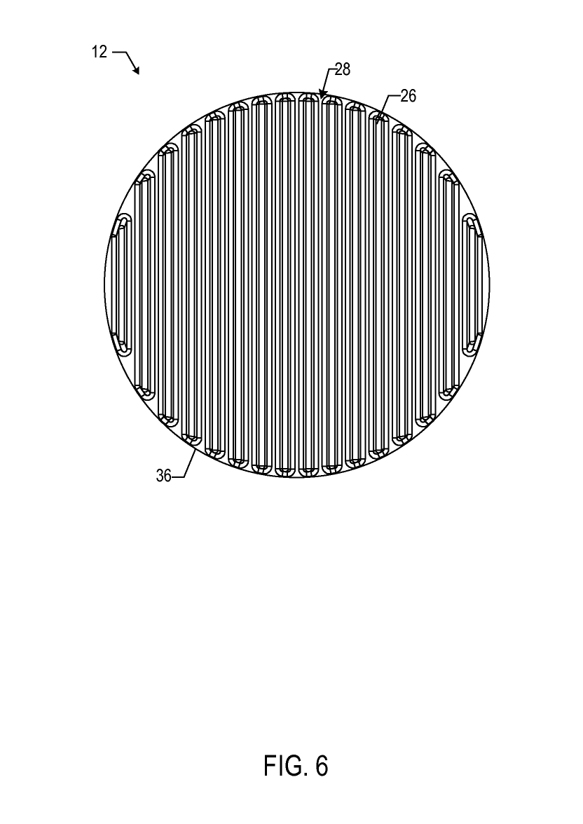

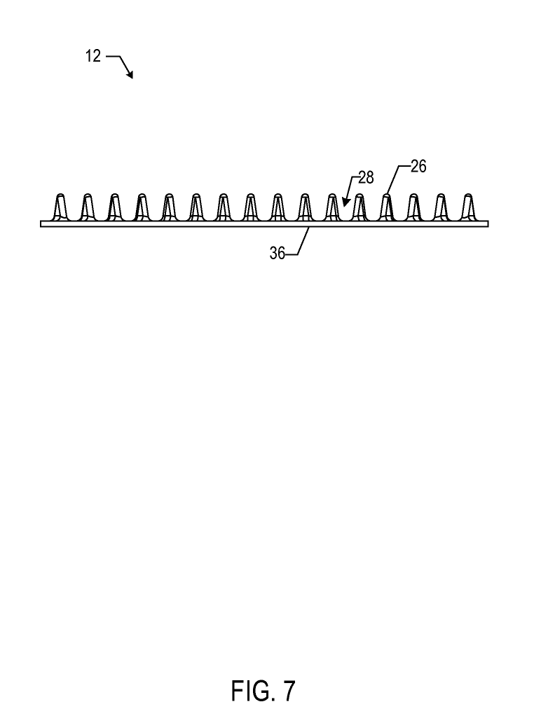

Referring now to the FIGS. 5 through 7, a grill pan insert 12 is shown. The grill pan insert 12 provides a food support frame for removable insertion into a traditional cooking pan, or like kitchen utensil. The grill pan insert 12 is defined to rest flatly, without any support members, legs, racks, or the like, upon an interior floor surface of a pan. Additionally, the grill pan insert 12 is adapted for use not only on a traditional stove-top setting with a traditional pan, but also the grill pan insert 12 is adapted and defined for placement within a cooking oven either by itself or combined within a larger pan, dish, or the like.

The grill pan insert 12 includes a food support frame having a base 36. The base 36 is depicted as disc-shaped, but in alternative embodiments, is one of square, rectangular, oval, and similar shapes. The disc-shaped base 36 of the food support frame is adapted to receive and evenly distribute heat from the underlying traditional cooking pan, or like cooking utensil. In this manner the grill pan insert 12 provides for uniform cooking of food items placed upon it. Furthermore, the even heating provides for generally uniform grill markings upon the cooked food item.

In at least one embodiment the grill pan insert 12 is manufactured from anodized aluminum. The anodized aluminum, or alternative material, utilized in the manufacture of the grill pan insert 12, is food-safe. In alternative embodiments, the grill pan insert 12 is manufactured from other materials so long as the material selected is food-safe and can withstand safely the heat of cooking on a stove-top or oven either in a pan or like utensil or by itself. Additionally, the material of manufacture is easily cleanable. In at least one embodiment, the grill pan insert 12 is manufactured from a dishwasher-safe material.

The grill pan insert 12 includes a multiplicity of ribs 26 integrally formed with the disc-shaped base 36. Each of the multiplicity of ribs 26 projects sharply upwardly from the disc-shaped base 36. The multiplicity of ribs 26 are placed in a generally parallel manner upon the disc-shaped base 36. The ribs 26 have very steep and high and narrow peaks to simulate a wire grate grill pattern. The very steep and high and narrow peaks provide for the imprinting of the wire grate grill pattern upon the food item. Additionally, by utilizing ribs 26 having very steep and high and narrow peaks, fats, oils, juices, and the like, are easily drained away from the food item. This contributes significantly to the objective of healthy cooking and eating.

A multiplicity of deep trenches 28 is alternatingly interposed between the multiplicity of ribs 26 on the food support frame. Together the multiplicity of ribs 26 and the multiplicity of deep trenches 28 form a generally U-shaped repeating pattern in the grill pan insert 10. Thus, the pattern formed with the multiplicity of ribs 26 and the multiplicity of deep trenches 28 alternatingly interposed is not a shallow wave-like or flute-like pattern. It is known that wave-like or flute-like patterns are not very steep and high and narrow peaks and as such do not provide for imprinting the wire grate grill pattern upon the food item and for draining fats, oils, juices, and the like, away from the food item as it is cooked.

In at least one embodiment of the grill pan insert 12, each of the multiplicity of ribs 26 is a height selected from the range of 0.75 inches to 1.00 inches in height from the disc-shaped base 36. It has been determined that a rib height selected from within this range is optimal both for imprinting the wire grate grill pattern upon the food item and for draining fats, oils, juices, and the like, away from the food item as it is cooked. In this embodiment, all ribs 26 are of the same predetermined height. Additionally, given that the ribs 26 emanate upwardly from the base 36 in a very steep manner, the depth of the trenches 28, is very close to the same measure as the height of the ribs 26.

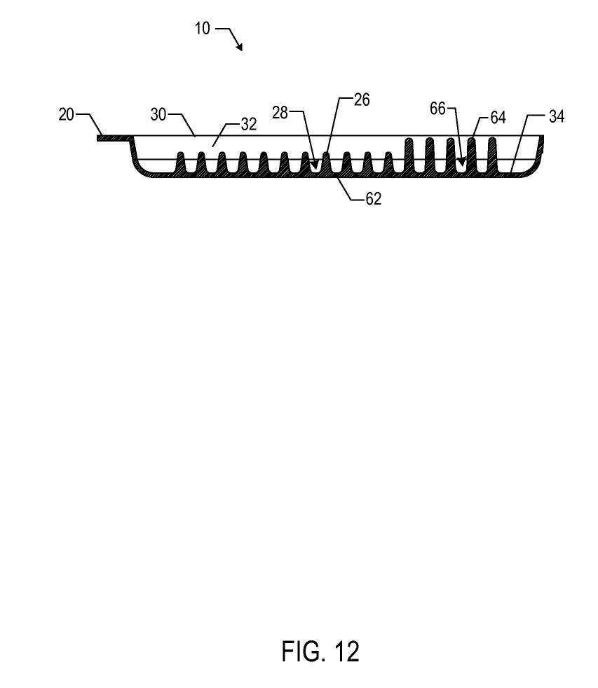

In at least one alternative embodiment of the grill pan insert 12, the heights of the ribs 26 vary. In this embodiment, the multiplicity of ribs 26 includes a first portion of ribs at a first height and a second portion of ribs at a second height, such that the grill pan insert has ribs of varied heights. By way of example, and as depicted in a grill pan embodiment in FIG. 12, this food platform insert can include ribs 26 and trenches 28 of one height and depth, and high ribs 64 and deep trenches 66 of a second height and depth, different from the height and depth of the first portion.

In at least one alternative embodiment of the grill pan insert 12, the multiplicity of ribs 26 includes a first portion of ribs at a first height selected from the range of 0.75 inches to 1.00 inches in height from the disc-shaped base 36 and a second portion of ribs at a second height that is higher than the first height, such that the grill pan insert has ribs of varied heights.

In at least one alternative embodiment of the grill pan insert 12, the multiplicity of ribs 26 includes a plurality of rib sections, each section having a varied height, such that the grill pan insert has ribs of varied heights.

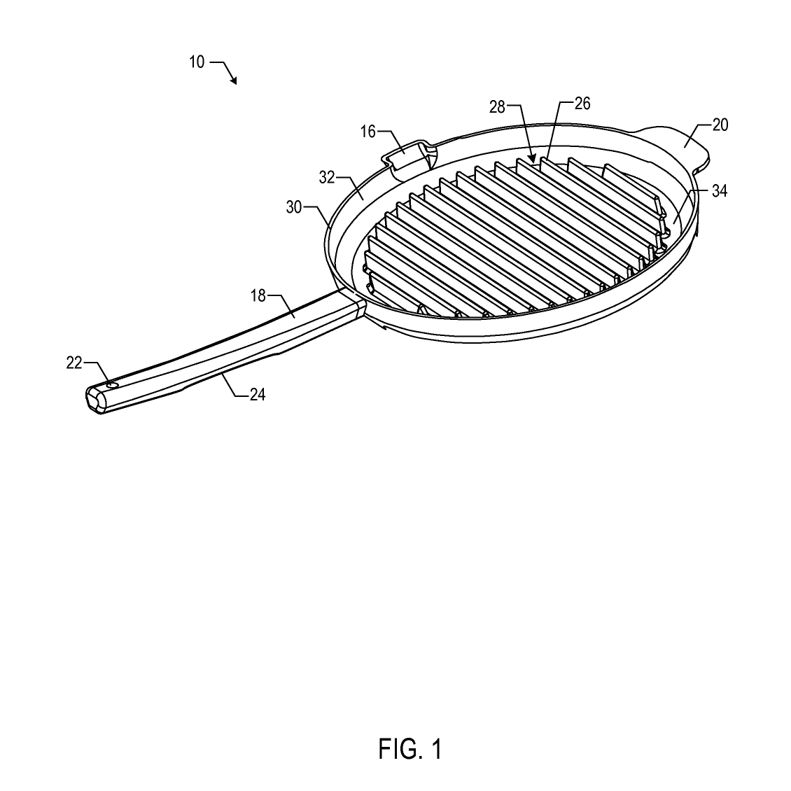

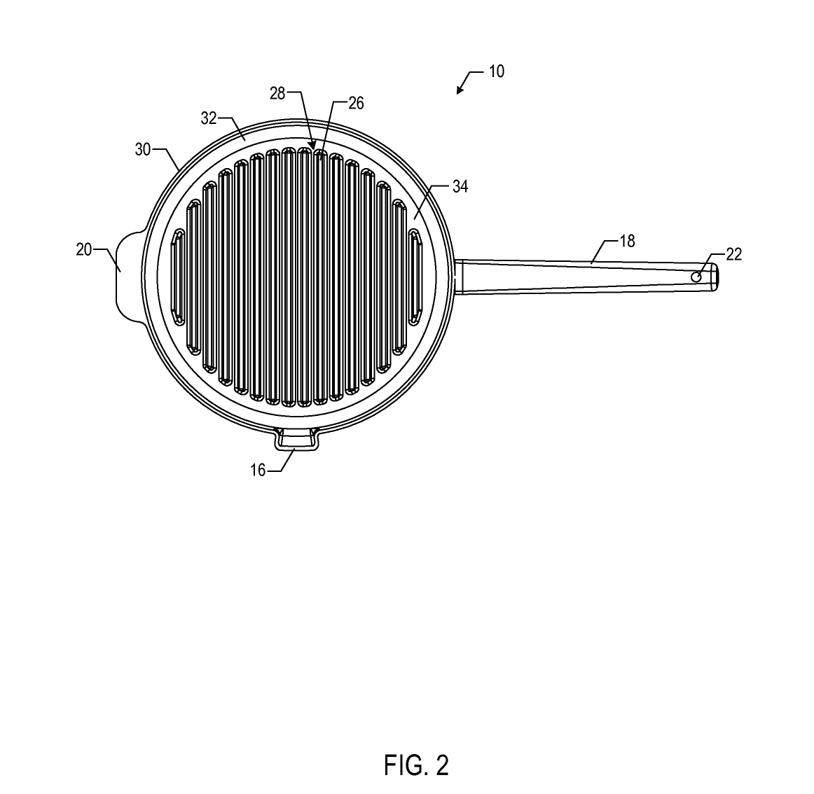

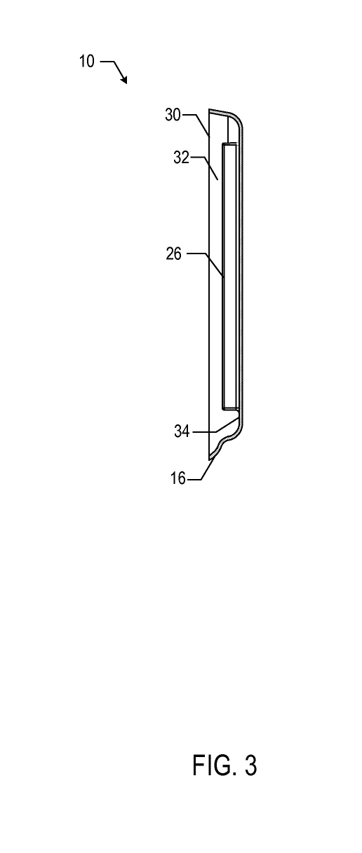

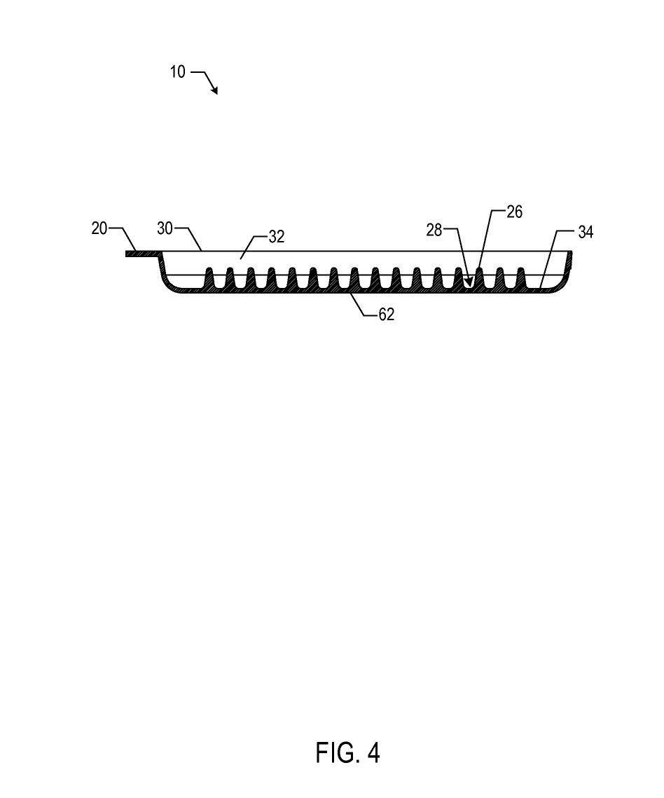

Referring now to the FIGS. 1 through 4 and 12, a cardio grill pan 10 is shown. The grill pan 12 includes many aspects and attributes of the grill pan insert 10 (depicted in FIGS. 5 through 7); however, the grill pan 12 is a pan-like device in and of itself wherein the rib and trench structures are integrally formed.

Defined within the grill pan 10 is a grill pattern assembly defined by a multiplicity of ribs 26 disposed in a generally parallel manner integrally formed with and emanating from a floor of the pan 34. The ribs 26 have very steep and high and narrow peaks to simulate a wire grate grill pattern. The very steep and high and narrow peaks provide for the imprinting of the wire grate grill pattern upon the food item. Additionally, by utilizing ribs 26 having very steep and high and narrow peaks, fats, oils, juices, and the like, are easily drained away from the food item. This contributes significantly to the objective of healthy cooking and eating.

A multiplicity of deep trenches 28 is alternatingly interposed between the multiplicity of ribs 26 pan floor 34. Together the multiplicity of ribs 26 and the multiplicity of deep trenches 28 form a generally U-shaped repeating pattern in the cardio grill pan 10. Thus, the pattern formed with the multiplicity of ribs 26 and the multiplicity of deep trenches 28 alternatingly interposed is not a shallow wave-like or flute-like pattern. It is known that wave-like or flute-like patterns are not very steep and high and narrow peaks and as such do not provide for imprinting the wire grate grill pattern upon the food item and for draining fats, oils, juices, and the like, away from the food item as it is cooked.

In at least one embodiment of the grill pan 10, each of the multiplicity of ribs 26 is a height selected from the range of 0.75 inches to 1.00 inches in height from the disc-shaped base 36. It has been determined that a rib height selected from within this range is optimal both for imprinting the wire grate grill pattern upon the food item and for draining fats, oils, juices, and the like, away from the food item as it is cooked. In this embodiment, all ribs 26 are of the same predetermined height. Additionally, given that the ribs 26 emanate upwardly from the base 36 in a very steep manner, the depth of the trenches 28, is very close to the same measure as the height of the ribs 26.

In at least one alternative embodiment of the grill pan 10, the heights of the ribs 26 vary. In this embodiment, the multiplicity of ribs 26 includes a first portion of ribs at a first height and a second portion of ribs at a second height, such that the grill pan insert has ribs of varied heights. By way of example, and as depicted in a grill pan embodiment in FIG. 12, this food platform insert can include ribs 26 and trenches 28 of one height and depth, and high ribs 64 and deep trenches 66 of a second height and depth, different from the height and depth of the first portion.

In at least one alternative embodiment of the grill pan 10, the multiplicity of ribs 26 includes a first portion of ribs at a first height selected from the range of 0.75 inches to 1.00 inches in height from the disc-shaped base 36 and a second portion of ribs at a second height that is higher than the first height, such that the grill pan insert has ribs of varied heights.

In at least one alternative embodiment of the grill pan 10, the multiplicity of ribs 26 includes a plurality of rib sections, each section having a varied height, such that the grill pan insert has ribs of varied heights.

The grill pan 10 also is defined by a perimeter rim 30 at the top edge of pan wall 32. The pan wall 32 extends downwardly from the perimeter rim 30 to the pan floor 34. The pan wall 32 and pan floor 34 collectively provide temporary containment of the fats, oils, juices, and the like, drained away from the food item as it is cooked. The grill pan 10 includes base 62. The base 62 is placed upon a stove top, an oven rack, or the like when in use.

The grill pan 10 includes a pan handle 18 in at least one embodiment. The pan handle 18 is utilized to grasp and lift the grill pan 10. In at least one example the pan handle 18 is formulated from a polymer. By way of example, in one embodiment, the pan handle 18 is synthetic polymer Nylon®. The pan handle 18 can also be plastic or cast stainless. An alternative material can be utilized for the pan handle 18 so long as it is food-safe and can withstand heat on or near a stove top. In at least one embodiment, the pan handle 18 is removable. In this embodiment, the pan handle 18 is removed, for example, before the grill pan 10 is placed into an oven.

The pan handle 18 includes, in at least one embodiment, aperture 22. With the aperture 22, the grill pan 10 can be hung or otherwise mounted when not in use for cooking.

The pan handle 18 includes, in at least one embodiment, grip 24. The grip 24 is adapted for gripping by a hand. The grip 24 is contoured, and as such, provides additional gripping ability and control of the grill pan 10 when in use.

The grill pan 10 includes a lift handle 20. The lift handle 20 is placed at one portion of the pan perimeter rim 30. The lift handle 20 is preferably opposite the pan handle 18. In this configuration, the lift handle 20 and the pan handle 18 both collectively provide lift to the grill pan 10 as it is drained or otherwise used.

The grill pan 10 includes a pour spout 16. The pour spout 16 is utilized to pour the drained the fats, oils, juices, and the like away from the food item. In at least one embodiment, the pour spout 16 is located along perimeter rim 30 at a location ninety degrees from the pan handle 18, in between the pan handle 18 and the lift handle 20.

In at least one embodiment the grill pan 10 is manufactured from anodized aluminum. The anodized aluminum, or alternative material, utilized in the manufacture of the grill pan 10, is food-safe. In alternative embodiments, the grill pan 10 is manufactured from other materials so long as the material selected is food-safe and can withstand safely the heat of cooking on a stove-top or oven either in a pan or like utensil or by itself. Additionally, the material of manufacture is easily cleanable. In at least one embodiment, the grill pan 10 is manufactured from a dishwasher-safe material.

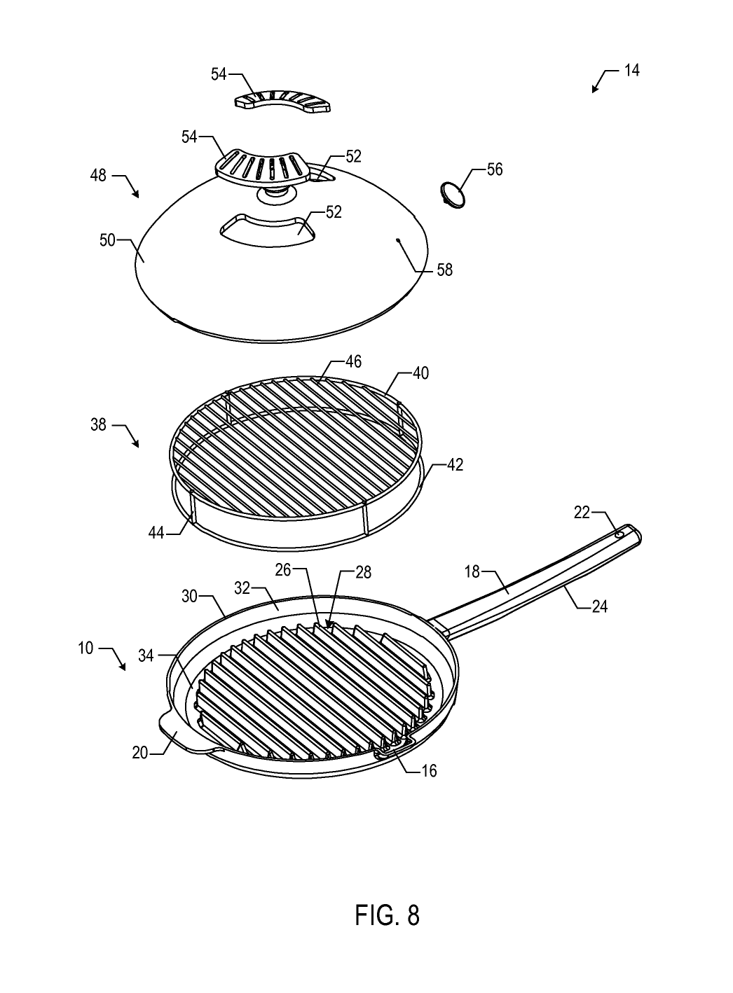

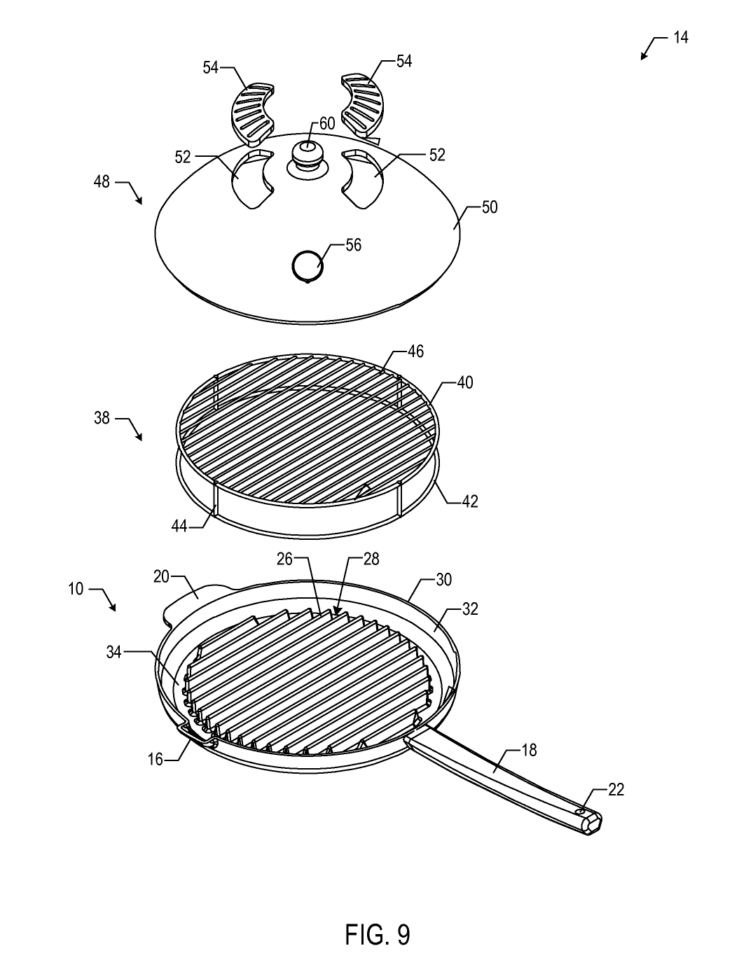

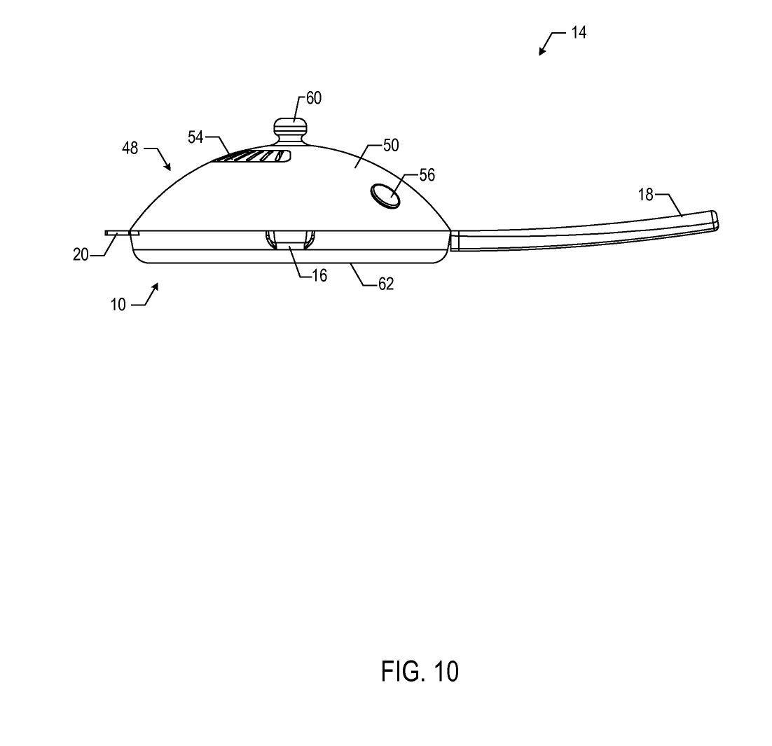

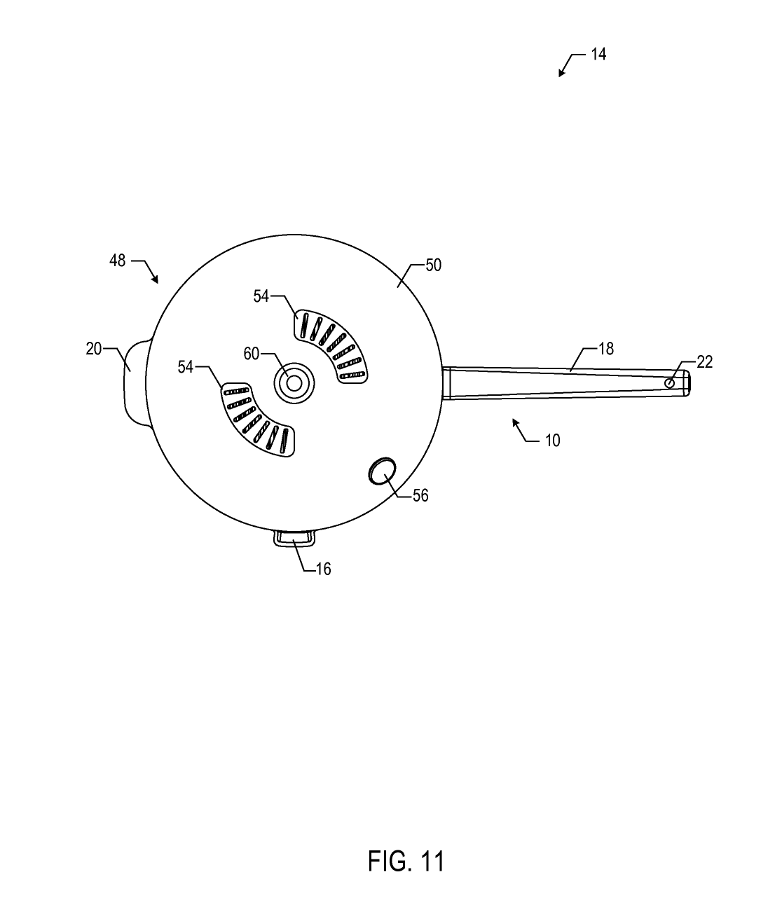

Referring now to the FIGS. 8 through 11, a grill pan assembly 14 is shown. The grill pan assembly 14 includes the grill pan 10 previously described and depicted in FIGS. 1 through 4 and 12. However, the grill pan assembly 14 of this embodiment also includes additional elements as described herein and depicted in the Figures.

The grill pan assembly 14 includes a tiered wire grate rack assembly 38. The rack assembly 38 is adapted for placement within the grill pan 10 to create a tiered cooking platform. As such the rack assembly 38 provides a steaming rack, or the like. Additionally, the rack assembly 38 provides a tiered platform that can be used to allow one type of food items to be cooked or heated closer to the heat while a second type of food item is kept at a higher level farther away from the direct heat.

As depicted in the Figures, the rack assembly 38 includes an upper ring 40 and a lower ring 42. The upper ring 40 and the lower ring 42 create the tiered platform cooking effect. The upper ring 40 and the lower ring 42 are connected one to another by a series of vertical bars 44. As depicted in the figures, the tiered rack assembly 38 provides for two cooking levels. However, upon reading of the technology disclosed and described herein, one of ordinary skill in the art could use layers greater than two in a cooking rack assembly.

The rack assembly 38 includes a grate 46 across the upper ring 40. The grate 46 provides the surface upon which to place one or more food items at a higher level from the grill pan 10 and its ribs 26. Foods such as fish, vegetables, or other delicate foods are ideally placed upon the grate 46 of the rack assembly 38 for cooking. Such foods are additional cooked away from direct heat and heating with steam when a lid is used with the grill pan 10. The grate 46 of the rack assembly 38 can also be used as a warming rack for food items.

The grill pan assembly 14 includes a lid assembly 48. The lid assembly 48 is adapted to sealably cover the grill pan 10. As such heat is maintained within the grill pan assembly 14. Additionally, the grill pan assembly 14 can serve as a steamer. The lid assembly 48 includes a lid 50. The lid 50, in at least one embodiment, is a clear glass cover. Alternatively, such as when used in the pressure cooker embodiment, the lid is a stronger material such as steel. In at least one embodiment, the lid 50 locks to the perimeter rim 30 of the grill pan 10. As such, the grill pan assembly 14 is adapted for use pressure cooker. Without the lid 50 locked, but yet in place on the grill pan 10, the grill pan assembly 14 is adapted for use as a steamer.

In at least one embodiment, the lid 50 also includes at least one adjustable vent 54 over a vent door 52 with the lid 50. As depicted the lid 50 includes two adjustable vents 54. Each adjustable vent 54 provides for the selective release of the exhaust and steam when cooking. This controlled release of steam also controls the temperature within, which can be identified with thermometer 56.

In at least one embodiment, the lid 50 also includes a lid handle 60. With the lid handle 60, the lid 50 is easily placed upon, or removed from, the grill pan 10. The lid handle 60 also provides a way in which an operator can grasp the lid 50 without the risk of a burn or discomfort from the heat in the lid 50.

In at least one embodiment, the grill pan assembly 14 includes a thermometer 56. In at least one embodiment, the thermometer 56 is placed in hole 50 in lid 50 of the lid assembly 48. The thermometer 56 is removable and replaceable. The thermometer 56 provides an interior temperature of the grill pan assembly 14. This is particularly helpful when cooking meats, and the like, when a minimum temperature is desired for food safety.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A grill pan insert comprising:
a food support frame having a base and adapted for removable insertion into a traditional cooking pan and defined to rest flatly, without support members, upon a floor surface of the pan; and
a grill pattern assembly defined by a plurality of ribs disposed in a generally parallel manner upon the disc-shaped base of the food support frame and having steep high narrow peaks to simulate a wire grate grill pattern imprint upon a food item and from which to drain fats, oils, juices, and the like away from the food item, a plurality of deep trenches alternatingly interposed between the plurality of ribs on the food support frame and having a generally U-shaped pattern.

2. The grill pan insert of claim 1, wherein the base of the food support frame is adapted to receive and evenly distribute heat from the underlying traditional cooking pan;
and wherein the base is disc-shaped.

3. The grill pan insert of claim 1, wherein each of the plurality of ribs is a height selected from the range of 0.75 inches to 1.00 inches in height from the disc-shaped base.

4. The grill pan insert of claim 1, wherein the plurality of ribs includes a first portion of ribs at a first height and a second portion of ribs at a second height, such that the grill pan insert has ribs of varied heights.

5. The grill pan insert of claim 1, wherein the plurality of ribs includes a first portion of ribs at a first height selected from the range of 0.75 inches to 1.00 inches in height from the disc-shaped base and a second portion of ribs at a second height that is higher than the first height, such that the grill pan insert has ribs of varied heights.

6. The grill pan insert of claim 1, wherein the plurality of ribs includes a plurality of rib sections, each section having a varied height, such that the grill pan insert has ribs of varied heights.

7. The grill pan insert of claim 1, wherein the grill pan insert is manufactured from anodized aluminum.

8. A grill pan comprising:
a pan within which to cook food;
a grill pattern assembly defined by a plurality of ribs disposed in a generally parallel manner integrally formed with and emanating from a floor of the pan and having steep high narrow peaks to simulate a wire grate grill pattern imprint upon a food item and from which to drain fats, oils, juices, and the like, away from the food item, a plurality of deep trenches alternatingly interposed between the plurality of ribs on the floor of the pan and having a generally U-shaped pattern; and
a pan handle with which to grasp and lift the grill pan.

9. The grill pan of claim 8, further comprising:
a lift handle disposed upon a pan rim opposite the pan handle.

10. The grill pan of claim 8, further comprising:
a pour spout through which to drain the fats, oils, juices, and the like away from the food item.

11. The grill pan of claim 8, wherein each of the plurality of ribs is a height selected from the range of 0.75 inches to 1.00 inches in height from the floor of the pan.

12. The grill pan of claim 8, wherein the plurality of ribs includes a first portion of ribs at a first height and a second portion of ribs at a second height, such that the grill pan insert has ribs of varied heights.

13. The grill pan of claim 8, wherein the plurality of ribs includes a first portion of ribs at a first height selected from the range of 0.75 inches to 1.00 inches in height from the floor of the pan and a second portion of ribs at a second height that is higher than the first height, such that the grill pan has ribs of varied heights.

14. The grill pan of claim 8, wherein the plurality of ribs includes a plurality of rib sections, each section having a varied height, such that the grill pan insert has ribs of varied heights.

15. The grill pan of claim 8, wherein the grill pan is manufactured from anodized aluminum.

16. A grill pan assembly comprising:
a pan within which to cook food;
a grill pattern assembly defined by a plurality of ribs disposed in a generally parallel manner integrally formed with and emanating from a floor of the pan and having steep high narrow peaks to simulate a wire grate grill pattern imprint upon a food item and from which to drain fats, oils, juices, and the like, away from the food item, a plurality of deep trenches alternatingly interposed between the plurality of ribs on the floor of the pan and having a generally U-shaped pattern;
a tiered wire grate adapted for placement within the pan to create a tiered cooking platform; and
a lid adapted to sealably cover the pan.

17. The grill pan assembly of claim 16, further comprising:
a pan handle with which to grasp and lift the grill pan;
a lift handle disposed upon a pan rim opposite the pan handle;
a pour spout through which to drain the fats, oils, juices, and the like away from the food item;
a plurality of adjustable vents disposed within the lid; and
a thermometer removably disposed within lid.

18. The grill pan assembly of claim 16, wherein each of the plurality of ribs is a height selected from the range of 0.75 inches to 1.00 inches in height from the floor of the pan.

19. The grill pan assembly of claim 16, wherein the plurality of ribs includes a plurality of rib sections, each section having a varied height, such that the grill pan insert has ribs of varied heights.

20. The grill pan assembly of claim 16, wherein the plurality of ribs includes a first portion of ribs at a first height and a second portion of ribs at a second height, such that the grill pan insert has ribs of varied heights.
